(19) United States
(12) Patent Application Publication
(10) Pub. No.: US 2010/0328414 A1
(43) Pub. Date: Dec. 30, 2010

(54) Optical Scanning Device and Image Forming Apparatus Equipped with the Same

(75) Inventor: Hiroki Takahashi, Osaka (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: KYOCERA MITA CORPORATION, Osaka (JP)

(21) Appl. No.: 12/824,821

(22) Filed: Jun. 28, 2010

(30) Foreign Application Priority Data
Jun. 29, 2009 (JP) 2009-153173

(51) Int. Cl. B41J 2/435; G02B 26/08

(52) U.S. Cl. 347/224; 359/204.1; 359/205.1

(57) ABSTRACT

An optical scanning device includes a light source for emitting first light beams, a deflecting unit that deflects the first light beams as second light beams having scanning lines that are substantially arc shaped, a scanning lens disposed in a light path of one of the second light beams, and a light-blocking member interposed between the deflecting unit and the scanning lens. The light-blocking member blocks reflected light generated from the one of the second light beams when the second light beam enters the scanning lens. The light-blocking member protrudes toward the second light beam path along at least a scanning area of the second light beam, and includes a protruding edge section curving in substantially a same arc shape as the scanning line.

This application is based upon and claims the benefit of priority from the corresponding Japanese Patent application No. 2009-153173, filed Jun. 29, 2009, the entire contents of which are incorporated herein by reference.

### BACKGROUND

1. Field

The present disclosure relates to an optical scanning device that is used in an image forming apparatus, such as a color laser printer or a digital color copy machine, and an image forming apparatus including the optical scanning device.

2. Description of the Related Art

A known image forming apparatus employing an electrophotographic method, such as a copy machine or a printer, includes an optical scanning device that emits a light beam modulated on the basis of input image data to the surface of a photoconductive drum evenly charged by charging means. An electrostatic latent image formed by the optical scanning device is developed into a toner image by developing means. Then, an image is formed by transferring this toner image onto a recording paper.

In response to the production of high speed color-image forming apparatuses, for example, tandem digital copy machines and laser printers have been put to practical use. In general, a tandem color-image forming apparatus has four photoconductive drums arranged in the moving direction of an intermediate transfer belt. A plurality of optical scanning devices corresponding to the photoconductive drums form electrostatic latent images by simultaneously exposing the photoconductive drums. The electrostatic latent images are then developed using different color developers, such as yellow, magenta, cyan, and black. Then, these toner images are transferred via the intermediate transfer belt in a superimposed state onto the recording paper to obtain a color image.

Such a tandem color-image forming apparatus is advantageous in high-speed printing since color images can be output at the same speed as monochrome images. However, when four optical scanning devices corresponding to the four photoconductive drums are provided, there is a problem in that the size of the apparatus increases. In response to the need for a small size image forming apparatus, there has been proposed an optical scanning device including a plurality of light sources that emit light beams for forming different color toner images, one rotating multifaceted mirror (polygon mirror) that deflects the plurality of light beams emitted from the light sources, and scanning lenses that guide the light beams to irradiate different photoconductive drums with the light beams.

In such an optical scanning device, however, when the plurality of deflected light beams pass through the scanning lenses before reaching the photoconductive drums, reflected light generated from the light beams being reflected at the surfaces of the scanning lenses, i.e., flare light, reaches other photoconductive drums, causing image degradation. Furthermore, the structure of the optical scanning device becomes more complex when the plurality of light beams are deflected at one polygon mirror to achieve miniaturization mentioned above, and thus image degradation caused by flare light becomes more likely to occur.

A method of preventing flare light and improving image quality by providing a light-blocking member between the image carrier and the scanning lenses at the scanning start position and scanning end position of the light beam has been proposed.

According to this method, flare light at both edge sections of the scanning lenses can be blocked; however, flare light generated at the center area in the scanning direction cannot be sufficiently blocked. Flare light at the center area is mostly reflected light generated when a light beam enters a scanning lens. When light-blocking members are merely disposed to block the flare light in the center area, the light beams that need to reach the photoconductive drums for image formation are also blocked and image degradation may be caused. The amount of generated flare light may be reduced by coating the scanning lens. This, however, results in an increase in costs.

### SUMMARY

The presently disclosed embodiments have been conceived in light of these problems, and it is an object of the present disclosure to provide an optical scanning device and an image forming apparatus capable of effectively blocking reflected light generated when a light beam emitted to a surface to be scanned enters a scanning lens and preventing image degradation due to the reflected light.

An optical scanning device includes a light sources configured to emit a plurality of light beams as first light beams, a deflecting unit configured to deflect and scan the first light beams emitted from the plurality of light sources as second light beams having scanning lines substantially arc shaped, a scanning lens disposed in light path at least one of the second light beams deflected and scanned by the deflecting unit, and a light-blocking member interposed between the deflecting unit and the scanning lens. The light-blocking member blocks reflected light generated from the at least one second light beam when the at least one second light beam enters the scanning lens, protrudes toward the second light beams along at least a scanning area of the second light beams, and includes a protruding edge section curving in substantially the same arc shape as the scanning line of the second light beam.

An image forming apparatus according to an embodiment includes the above-described optical scanning device, at least two image forming units having an image carrier carrying a toner image, a transfer unit configured to transfer the toner image formed by the image forming unit onto the recording medium, and a fixing unit configured to fix the toner image transferred by the transfer unit on the recording medium.

Characteristics and advantages will be described in detail below with reference to drawings.

### BRIEF DESCRIPTION OF THE DRAWINGS

FIG. 1 is a schematic view of the entire structure of a tandem color-image forming apparatus equipped with an optical scanning device according to a first embodiment;

FIG. 2 is a plan view of the internal structure of the optical scanning device according to the first embodiment;

FIG. 3 is a sectional side view of the internal structure of the optical scanning device according to the first embodiment;

FIG. 4 illustrates the inside of the optical scanning device according to the first embodiment and is a schematic side view of light-blocking ribs, a polygon mirror, their peripheries, and light paths of a first light beam and a second light beam;

FIGS. 5A and 5B are partially enlarged views schematically illustrating the light paths of the first light beam and the second light beam with respect to the polygon mirror in FIG. 4, where FIG. 5A is a top view of FIG. 4 and FIG. 5B is viewed from the same direction as FIG. 4;

FIG. 6 schematically illustrates the light paths of flare light generated at scanning lenses when blocking members are not provided;

FIGS. 7A and 7B are schematic views illustrating the positional relationship of a light-blocking rib, which is substantially rectangular when viewed from a direction orthogonal to the scanning direction, the scanning line of a second light beam, and flare light, where, in FIG. 7A, a protruding edge section of the light-blocking rib is disposed lower than the scanning line of the second light beam, and, in FIG. 7B, the protruding edge section of the light-blocking rib is higher than the flare light;

FIG. 8 schematically illustrates the positional relationship of a light-blocking rib used in the optical scanning device according to the first embodiment, a scanning line of a second light beam, and flare light; and

FIG. 9 is a top view schematically illustrating a light-blocking rib and a polygon mirror included in an optical scanning device according to a second embodiment.

### DETAILED DESCRIPTION

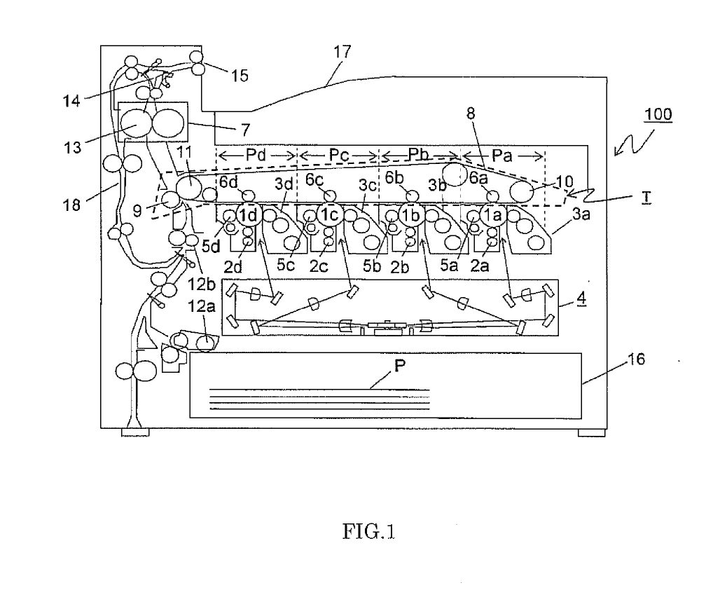

Embodiments will now be described below with reference to the drawings. FIG. 1 is a schematic sectional view of an image forming apparatus equipped with an optical scanning device according to a first embodiment. Here, FIG. 1 illustrates a tandem color-image forming apparatus 100. Four image forming sections Pa, Pb, Pc, and Pd are arranged in order from upstream (right side in FIG. 1) in the moving direction of an intermediate transfer belt 8 described later inside the main body of a color-image forming apparatus 100. The image forming sections Pa, Pb, Pc, and Pd correspond to respective images of four different colors (cyan, magenta, yellow, and black, respectively) and form different color images in sequence through the processes of charging, exposing, and developing.

The image forming sections Pa, Pb, Pc, and Pd include photoconductive drums (image carriers) 1a, 1b, 1c, and 1d, respectively, that carry visible images (toner images) of different colors and the intermediate transfer belt 8 that rotates clockwise in FIG. 1 by driving means (not shown) and that adjoins the image forming sections Pa, Pb, Pc, and Pd. The toner images formed on the photoconductive drums 1a, 1b, 1c, and 1d are transferred in order onto the intermediate transfer belt 8 that moves while contacting the photoconductive drums 1a, 1b, 1c, and 1d. Then, a secondary transfer roller 9 transfers the toner images onto a transfer paper P, which is an example of a recording medium. Recording media include transfer papers, fabric, transparent sheets, and other sheets on to which toner images can be transferred. A transfer unit includes the intermediate transfer belt 8, the secondary transfer roller 9 and primary transfer rollers 6a, 6b, 6c, and 6d described later. The transferred toner images are fixed onto the transfer paper P at a fixing unit 7. Then, the transfer paper P with the fixed toner image is ejected from the main body of the apparatus. While the photoconductive drums 1a, 1b, 1c, and 1d are rotated counterclockwise in FIG. 1, image forming processes are carried out on the photoconductive drums 1a, 1b, 1c, and 1d.

The transfer paper P onto which the toner images are transferred is accommodated in a paper cassette 16 disposed in the lower part of the color-image forming apparatus 100 and is conveyed to the secondary transfer roller 9 through a feeding roller 12a and a resist roller pair 12b. The intermediate transfer belt 8 comprises a dielectric resin sheet. An endless belt formed by bonding both ends of the dielectric resin sheet to each other in an overlapping manner or a seamless belt without any joints is used for the intermediate transfer belt 8.

Next, the image forming sections Pa, Pb, Pc, and Pd will be described. Around and below the photoconductive drums 1a, 1b, 1c, and 1d, which are mounted in such a manner that they freely rotate, there are provided chargers 2a, 2b, 2c, and 2d that charge photoconductive drums 1a, 1b, 1c, and 1d, respectively, an optical scanning device 4 that exposes the photoconductive drums 1a, 1b, 1c, and 1d with image information, development units 3a, 3b, 3c, and 3d that form toner images on the photoconductive drums 1a, 1b, 1c, and 1d, respectively, and cleaning units 5a, 5b, 5c, and 5d that respectively remove residual developer (toner) on the photoconductive drums 1a, 1b, 1c, and 1d.

When an external computer connected to the color-image forming apparatus 100 sends image signals to the color-image forming apparatus 100, first, the chargers 2a, 2b, 2c, and 2d evenly charge the surfaces of the photoconductive drums 1a, 1b, 1c, and 1d, respectively. Then, the optical scanning device 4 emits laser beams to form electrostatic latent images corresponding to image signals on the photoconductive drums 1a, 1b, 1c, and 1d. The development units 3a, 3b, 3c, and 3d are filled with predetermined amounts of different color toners of cyan, magenta, yellow, and black, respectively, by supplying devices (not shown) corresponding to different color toner, respectively. The toners are supplied from the development units 3a, 3b, 3c, and 3d onto the photoconductive drums 1a, 1b, 1c, and 1d, respectively. By electrostatically attaching the toners, toner images are formed corresponding to electrostatic latent images, which are formed by exposure by to the optical scanning device 4.

After an electric field is applied to the intermediate transfer belt 8 by a predetermined transfer voltage, the primary transfer rollers 6a, 6b, 6c, and 6d transfer, in order, cyan, magenta, yellow, and black toner images on the photoconductive drums 1a, 1b, 1c, and 1d, respectively, onto the intermediate transfer belt 8 to form a full color toner image. These four color toner images are formed with a corresponding position relationships, which are set beforehand, for forming a full color image. Residual toner on the surfaces of the photoconductive drums 1a, 1b, 1c, and 1d is then removed by the cleaning units 5a, 5b, 5c, and 5d, respectively.

The intermediate transfer belt 8 is extended across a delivery roller 10 upstream and a driving roller 11 downstream. As the driving roller 11 is rotated by a driving motor (not shown), the intermediate transfer belt 8 starts to rotate in the clockwise direction. As the intermediate transfer belt 8 rotates, the transfer paper P is conveyed, in a predetermined timing, from the resist roller pair 12b to a secondary transfer nip portion between the secondary transfer roller 9 adjoining the intermediate transfer belt 8, where the full color image is transferred on to the transfer paper P. The transfer paper P onto which the toner images are transferred is then conveyed to the fixing unit 7.

The transfer paper P conveyed to the fixing unit 7 is heated and pressed by a fixing roller pair 13 to fix the toner images to the surface of the transfer paper P to form a full color image. The delivery direction of the transfer paper P on which the full color image is formed is determined by a branching section 14 branching out in a plurality of directions. When images are formed on only one side of the transfer paper P, the transfer paper P is directly ejected into an ejection tray 17 by an ejection roller pair 15.

On the other hand, when images are formed on both sides of the transfer paper P, the branching section 14 sends the transfer paper P that has passed through the fixing unit 7 to a paper conveying path 18, where the image side is inverted, and the transfer paper P is then further conveyed to the secondary transfer nip portion again. Next, the secondary transfer roller 9 transfers the next images formed on the intermediate transfer belt 8 onto the other side of the transfer paper P on which images were not yet formed. After the transfer paper P is again conveyed to the fixing unit 7, where the toner images are fixed on to the transfer paper P, the transfer paper P is ejected into the ejection tray 17.

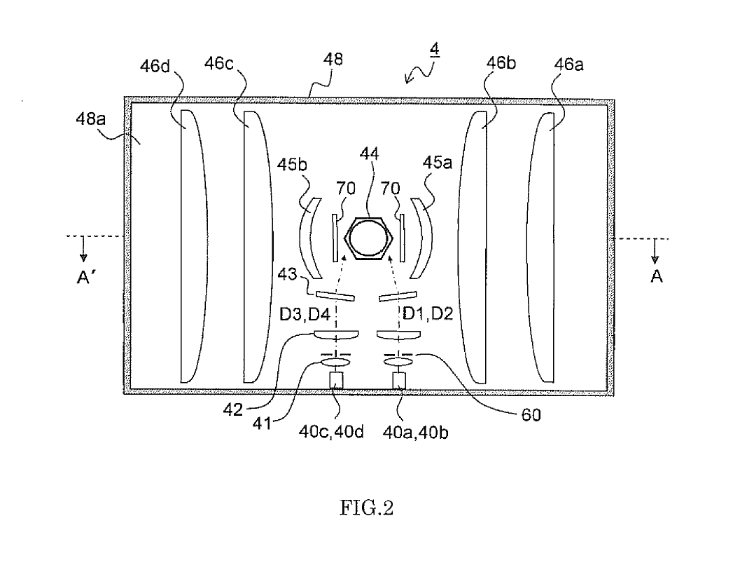

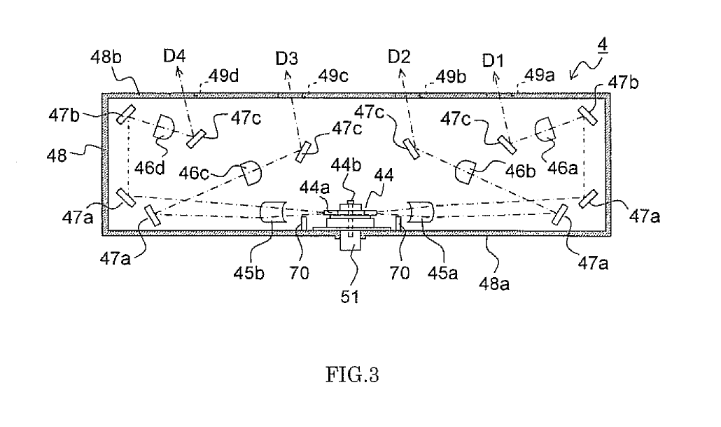

FIG. 2 is a plan view of the internal structure of the optical scanning device 4 according to the first embodiment. FIG. 3 is a sectional side view (taken along line AA′ in FIG. 2) of the internal structure of the optical scanning device 4. Flat mirrors 47a, 47b, and 47c are not shown in FIG. 2. As shown in FIGS. 2 and 3, the optical scanning device 4 has a housing 48. A polygon mirror (deflecting unit) 44 is disposed at substantially the center of a bottom surface 48a of the housing 48. With this embodiment, the polygon mirror 44 is composed of a regular-hexagonal rotating multifaceted mirror having six deflecting surfaces 44a on the sides and is rotated around a rotary shaft 44b at a predetermined speed by a polygon motor 51.

Near the edge section of the front surface (bottom area in FIG. 2) of the housing 48, four light sources 40a, 40b, 40c, and 40d are disposed along the horizontal direction in FIG. 2. The light sources 40a and 40b and the light sources 40c and 40d are respectively illustrated as one light source in FIG. 2. Actually, however, the light sources overlap in the sub-scanning direction (direction perpendicular to the page). The light sources 40a, 40b, 40c, and 40d include laser diodes (LDs) and emit light beams (laser beams) D1, D2, D3, and D4 optically modulated on the basis of image signals.

Between the light sources 40a, 40b, 40c, and 40d and the polygon mirror 44, four collimator lenses 41 corresponding to the light sources 40a, 40b, 40c, and 40d and four apertures 60 configured to adjust the light path widths of the light beams D1, D2, D3, and D4 that have passed through the collimator lenses 41 are interposed. Furthermore, between apertures 60 and the polygon mirror 44, two cylindrical lenses 42 and two reflection mirrors 43 are disposed. The light beams D1 and D2 that have passed through the apertures 60 respectively pass one of the cylindrical lenses 42, and the light beams D3 and D4 that have passed through the apertures 60 respectively pass the other cylindrical lens 42. One of the reflection mirrors 43 guides the light beams D1 and D2 that have passed through one of the cylindrical lenses 42 to the deflecting surfaces 44a of the polygon mirror 44, and the other reflection mirror guides the light beams D3 and D4 that have passed through the other cylindrical lens 42 to the deflecting surfaces 44a of the polygon mirror 44. The collimator lenses 41 and the apertures 60 corresponding to the light sources 40a and 40b and the light sources 40c and 40d are respectively illustrated as one in FIG. 2. Actually, however, the collimator lenses 41 and the apertures 60 overlap in the sub-scanning direction.

The collimator lenses 41 form the light beams D1, D2, D3, and D4 emitted from the light sources 40a, 40b, 40c, and 40d, respectively, into substantially parallel fluxes of light. The cylindrical lenses 42 have predetermined refractive power only in the sub-scanning direction (vertical direction in FIG. 3). Inside the housing 48, first scanning lenses (scanning lenses) 45a and 45b are disposed facing each other with the polygon mirror 44 interposed therebetween, and second scanning lenses 46a and 46d are disposed facing each other with the polygon mirror 44 interposed therebetween and second scanning lenses 46b and 46c are disposed facing each other with the polygon mirror 44 interposed therebetween. The first scanning lenses 45a and 45b and the second scanning lenses 46a, 46b, 46c, and 46d have a fθ characteristic and focus light beams D1, D2, D3, and D4 deflected by the polygon mirror 44 onto the photoconductive drums 1a, 1b, 1c, and 1d (see FIG. 1). Flat mirrors 47a, 47b, and 47c are respectively disposed in the light paths of the light beams D1, D2, D3, and D4 from the polygon mirror 44 to the photoconductive drums 1a, 1b, 1c, and 1d.

Scanning of the light beams D1 and D2 by the optical scanning device 4 having the above-described structure will be described. First, the light beams D1 and D2 emitted from the light sources 40a and 40b, respectively, are formed into substantially parallel fluxes of lights by the collimator lenses 41, and the light path widths of the light beams D1 and D2 are adjusted by the apertures 60. Next, the light beams D1 and D2 that are formed into substantially parallel fluxes of lights enter the cylindrical lens 42. The light beams D1 and D2 that enter the cylindrical lens 42 maintain their parallel fluxes in cross-sections in the main scanning direction but are converged in the sub-scanning direction to form line images on the deflecting surfaces 44a of the polygon mirror 44. At this time, to easily separate the light paths of the light beams D1 and D2 deflected by the polygon mirror 44, the light beams D1 and D2 enter the deflecting surfaces 44a in the sub-scanning direction at different angles.

After the light beams D1 and D2 that have entered the polygon mirror 44 are deflected at equal angular speeds by the polygon mirror 44, the first scanning lens 45a deflects the light beams D1 and D2 at equal speeds. The light beam D1 that has passed through the first scanning lens 45a is reflected at flat mirrors 47a and 47b, which are disposed in the light path of the light beam D1, and the light beam D2 that has passed through the first scanning lens 45a is reflected at flat mirror 47a, which is disposed in the light path of the light beam D2. Therefore the light beams D1 and D2 are separated from each other. Then, the light beam D1 enters the second scanning lens 46a, and the light beam D2 enters the second scanning lens 46b, where the light beams D1 and D2 are deflected at equal speeds at the second scanning lenses 46a and 46b. Then, the light beams D1 and D2 deflected at equal speeds are reflected at the flat mirrors 47c disposed in respective light paths and reach photoconductive drums 1a and 1b through windows 49a and 49b, respectively, formed in the upper surface 48b of the housing 48.

In a similar manner, after the light beams D3 and D4 emitted from the light sources 40c and 40d, respectively, pass through the collimator lenses 41 and the cylindrical lens 42, they are deflected at equal angular speeds by the polygon mirror 44, and then the first scanning lens 45b deflects the light beams D3 and D4 at equal speeds. Then, the light beam D3 is reflected at the flat mirror 47a, and the light beam D4 is reflected at the flat mirrors 47a and 47b. Therefore the light beams D3 and D4 are separated from each other. Next, the light beam D3 enters the second scanning lens 46c, and the light beam D4 enters the second scanning lens 46d, where the light beams D3 and D4 are deflected at equal speeds. Then, the light beams D3 and D4 are reflected at the flat mirrors 47c and reach photoconductive drums 1c and 1d, respectively, through windows 49c and 49d, respectively, formed in the upper surface 48b of the housing 48.

Light-blocking ribs (light-blocking members) 70 that protrude upward from the bottom surface 48a of the housing 48 are interposed between the polygon mirror 44 and the first scanning lenses 45a and 45b. In the optical scanning device 4 of this embodiment, flare light generated at the first scanning lenses 45a and 45b from the light beams D1 and D4 deflected by the polygon mirror 44 reach the polygon mirror 44, etc. Therefore, it is difficult for the flare light generated from the light beams D1 and D4 to reach the first scanning lenses 45b and 45a, which are disposed on the opposite sides of the polygon mirror 44. Thus, the light-blocking ribs 70 are provided only for protecting flare light generated from the light beams D2 and D3.

Next, a method of preventing the flare light that is generated at the first scanning lenses 45a and 45b from the incident light beams D2 and D3 from reaching the first scanning lenses 45b and 45a, respectively, i.e., reaching the photoconductive drums 1c and 1b, respectively, will be described. A method of preventing the flare light generated at the first scanning lens 45b from the incident light beam D3 emitted to reach the photoconductive drum 1c from reaching the photoconductive drum 1b will be described below. The relationship between the light beam D2 and the photoconductive drum 1c would be the same.

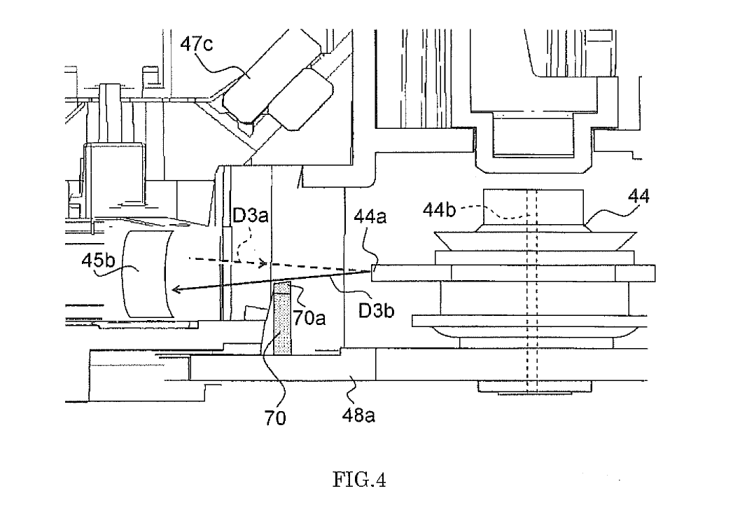

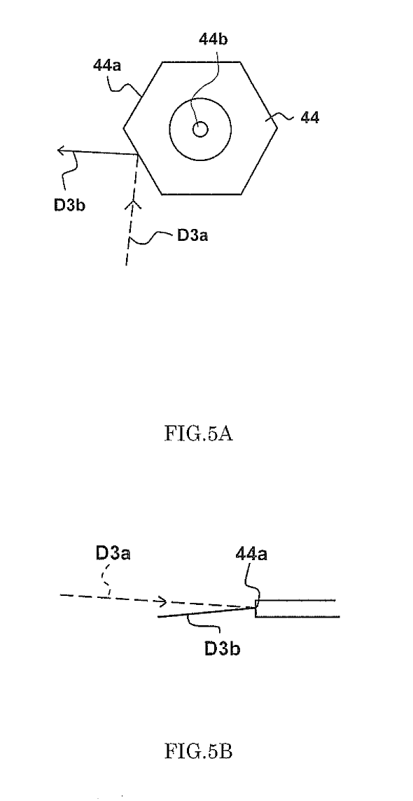

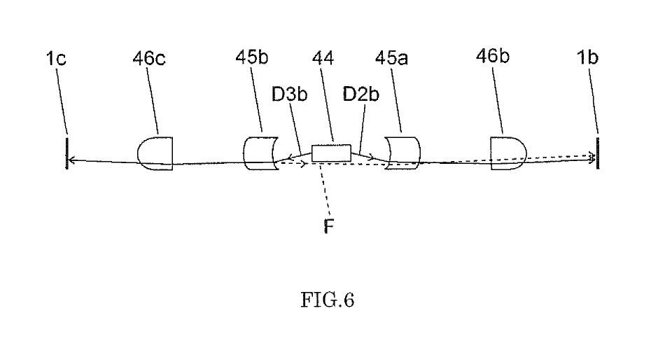

Part of the light beam D3 that enters the polygon mirror 44 is referred to as a first light beam D3a, and part of the light beam D3 that is deflected at the polygon mirror 44 is referred to as a second light beam D3b (see FIGS. 4 and 5). Similarly, part of the light beam D2 that enters the polygon mirror 44 is referred to as a first light beam D2a (not shown), and part of the light beam D2 that is deflected at the polygon mirror 44 is referred to a second light beam D2b (see FIG. 6).

FIG. 4 illustrates the inside of the optical scanning device 4 according to the first embodiment and is a schematic side view of the light-blocking ribs 70, the polygon mirror 44, their peripheries, and the light paths of the first light beam D3a and the second light beam D3b with respect to the polygon mirror 44. FIG. 5A is a partially enlarged top view of FIG. 4 schematically illustrating the light paths of the first light beam D3a and the second light beam D3b with respect to the polygon mirror 44 in FIG. 4, and FIG. 5B is a partially enlarged view of FIG. 4 from the same direction as FIG. 4. FIG. 6 schematically illustrates the light path of the flare light generated at the first scanning lenses 45a and 45b when blocking members are not provided.

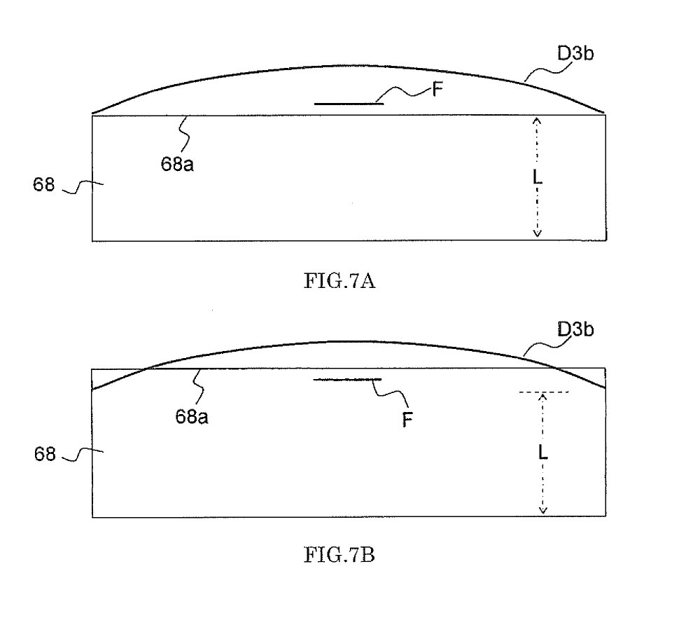

FIGS. 7A and 7B are schematic views illustrating the positional relationship of a light-blocking rib 68, which is substantially rectangular when viewed from a direction orthogonal to the scanning direction, the scanning line of the second light beam D3b, and the flare light, where, in FIG. 7A, the upper edge section of the light-blocking rib 68 is disposed lower than the scanning light, and, in FIG. 7B, the upper edge section of the light-blocking rib 68 is disposed higher than the flare light. Components that are the same as those illustrated in FIGS. 2 and 3 are represented by the same reference numerals and descriptions thereof are omitted. In FIGS. 4 and 5B, the first light beam D3a (represented by a broken line) and the second light beam D3b (represented by a solid line) are schematically illustrated on the same plane for ease of description only.

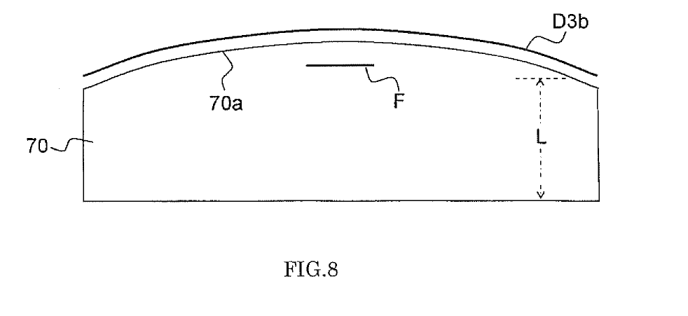

As shown in FIGS. 4, 5A, and 5B, the first light beam D3a enters one of the deflecting surfaces 44a from above, whereas the second light beam D3b deflected at the deflecting surface 44a travels downward. The scanning line of the second light beam D3b curves into a substantially arc shape protruding upward due to the rotation of the deflecting surface 44a (see FIGS. 7 and 8) and enters the first scanning lens 45b. Reflected light (flare light) is generated mainly in the center area in the scanning direction (the direction perpendicular to the page of FIG. 4 and the horizontal direction in FIGS. 7 and 8) by reflecting the entering second light beam D3b at the inner lens surface of the first scanning lens 45b.

Here, the shape of the scanning line is defined by the shape of the scanning line in the sub-scanning direction (the direction orthogonal to the scanning direction). When the scanning line of the second light beam D3b curves into a substantially arc shape, this means the shape of the scanning line of the second light beam D3b in the sub-scanning direction curves into a substantially arc shape. When the light-blocking ribs 70 are not provided between the polygon mirror 44 and the first scanning lens 45b, flare light F generated at the first scanning lens 45b, as shown in FIG. 6, passes under the polygon mirror 44, enters the first scanning lens 45a, and then reaches the photoconductive drum 1b. As a result, the formation of an electrostatic latent image by the second light beam D2b on the photoconductive drum 1b is affected with flare light F, and image degradation may occur.

Now, as shown in FIGS. 7A and 7B, a case in which the light-blocking rib 68, which is substantially rectangular when viewed from a direction orthogonal to the scanning direction (the direction perpendicular to the page), is provided between the polygon mirror 44 and the first scanning lens 45b will be described. As shown in FIG. 7A, when the height of an upper edge section 68a of the light-blocking rib 68 is set to a height L that does not block the second light beam D3b from entering the first scanning lens 45b, i.e., a height lower than that of both ends in the scanning direction of the scanning line of the second light beam D3b, the flare light F cannot be blocked by the light-blocking rib 68.

Moreover, as shown in FIG. 7B, when the height of the upper edge section 68a of the light-blocking rib 68 is set to a height that can block the flare light F, the flare light F can be prevented from reaching the first scanning lens 45a (see FIG. 6). Since, however, both ends, in the scanning direction, of the scanning line of the second light beam D3b are also blocked, the second light beam D3b corresponding to the both ends cannot enter the first scanning lens 45b (see FIGS. 4 and 6) and thus cannot reach the photoconductive drum 1c. As a result, image degradation occurs.

FIG. 8 schematically illustrates the positional relationship of a light-blocking rib 70 used in the optical scanning device 4 according to the first embodiment, the scanning line of a second light beam D3b, and flare light F. Components that are the same as those illustrated in FIG. 4 are represented by the same reference numerals and descriptions thereof are omitted.

As shown in FIG. 8, the light-blocking rib 70 having an upper edge section (protruding edge section) 70a that is curved in the same direction as the scanning area of the second light beam D3b when viewed in a direction orthogonal to the scanning direction (the direction perpendicular to the page of FIG. 8 and the horizontal direction in FIG. 4) is interposed between the polygon mirror 44 and the first scanning lens 45b. The light-blocking rib 70 is formed with substantially the same length as the scanning area of the second light beam D3b in the scanning direction.

The light-blocking rib 70 protrudes upward from the bottom surface 48a of the housing 48 toward the second light beam D3b. In other words, the light-blocking rib 70 protrudes toward the second light beam D3b from the side opposite to the first light beam D3a with respect to the second light beam D3b in the axial direction of the rotary shaft 44b of the polygon mirror 44 (see FIG. 4). The upper edge section 70a of the light-blocking rib 70 is substantially arc shaped concentric with the scanning line of the second light beam D3b. Furthermore, the curved upper edge section 70a of the light blocking rib 70 is oblique in the traveling direction of the second light beam D3b (see FIG. 4).

In this way, by curving the upper edge section 70a of the light-blocking rib 70 in the same direction as the scanning line of the second light beam D3b, the second light beam D3b is not prevented from entering the first scanning lens 45b. Moreover, by disposing the upper edge section 70a of the light-blocking rib 70 close to the scanning line of the second light beam D3b, the flare light F generated at the first scanning lens 45b from the incident second light beam D3b can be blocked. As a result, the flare light F can be effectively blocked, and image degradation caused by the flare light F can be prevented.

In this embodiment, the upper edge section 70a of the light-blocking rib 70 is substantially arc shaped concentric with the scanning line of the second light beam D3b, as described above. Therefore, the light-blocking rib 70 may be disposed even closer to the scanning line of the second light beam D3b, and thus the distance between the scanning line of the second light beam D3b and the upper edge section 70a can be made smaller entirely along the scanning direction. Thus, the flare light F can be blocked even more effectively.

The shape of the upper edge section 70a is not particularly limited to the embodiment described above. However, if the radius of curvature of the upper edge section 70a becomes excessively greater than the radius of curvature of the scanning line of the second light beam D3b, the flare light F generated in the center area in the scanning direction may not be sufficiently blocked. On the other hand, if the radius of curvature of the upper edge section 70a becomes excessively smaller than the radius of curvature of the scanning line of the second light beam D3b, the flare light F generated at both ends in the scanning direction may not be sufficiently blocked. Therefore, the shape of the upper edge section 70a may be set suitably within such extremities.

So long as the light-blocking rib 70 is formed at least along the scanning area of the second light beam D3b, the width of the light-blocking rib 70 in the scanning direction is not particularly limited. In this embodiment, the width is set substantially the same as the length of the scanning area of the second light beam D3b. Instead, however, the light-blocking rib 70 may have a width greater than the scanning area of the second light beam D3b in the scanning direction and at least the portion equivalent to the scanning area of the second light beam D3b at the upper edge section 70a curved in the same manner as described above.

In the above description, the upper edge section 70a is oblique in the traveling direction of the second light beam D3b. Instead, however, the upper edge section 70a may be formed substantially evenly in the horizontal direction. The thickness of the light-blocking rib 70 is not particularly limited and may be set to a thickness suitable to the structure of the device. The distance between the upper edge section 70a and the scanning line of the second light beam D3b is not particularly limited and may be set to any suitable distance that does not substantially block the second light beam D3b but does substantially block the flare light F.

The position of the light-blocking rib 70 between the polygon mirror 44 and the first scanning lens 45b is not particularly limited so long as the light-blocking rib 70 does not substantially block the second light beam D3b but does substantially block the flare light F and may be set to any position suitable for the structure of the device. The light-blocking rib 70 is formed separately from the housing 48 in the first embodiment. Instead, however, the light-blocking rib 70 may be formed integrally with the housing 48.

The shape of the above-described light-blocking rib 70 and its position may be suitably set on the basis of, for example, experimental results of preliminary experiments conducted to determine the curvature of the scanning line of the second light beam D3b, the reflection angle of the second light beam D3b with respect to the deflecting surfaces 44a, the generation of the flare light F, and so on.

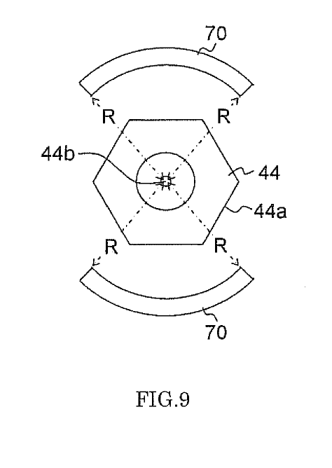

FIG. 9 is a top view of light-blocking ribs 70 and a polygon mirror 44 used in the optical scanning device 4 according to a second embodiment. In this embodiment, the light-blocking ribs 70 are each substantially arc shaped with a radius R around a rotary shaft 44b of a polygon mirror 44. Since other structures are the same as those of the first embodiment, descriptions thereof are omitted.

In the periphery of the polygon mirror 44, heated air is generated by the high-speed rotation of the polygon mirror 44. The generated heated air moves in substantially a circle around the rotary shaft 44b of the polygon mirror 44 as the polygon mirror 44 rotates. However, when the heated air flow is disturbed, retention of heated air may occur, causing a reduction in the cooling efficiency.

Thus, in this embodiment, the light-blocking ribs 70 are each substantially arc shaped with a radius R around the rotary shaft 44b of the polygon mirror 44. In this way, the flow of the heated air generated in the periphery of the polygon mirror 44 can be prevented from being disturbed, and a reduction in the cooling efficiency in the periphery of the polygon mirror 44 can be prevented.

The present invention is not limited to the embodiments described above and may include various modifications within the scope of the invention. For example, in the embodiment described above, the first scanning lenses 45a and 45b and the second scanning lenses 46a, 46b, 46c, and 46d are disposed in the light paths between the polygon mirror 44 and the photoconductive drums 1a, 1b, 1c, and 1d. Instead, however, only the first scanning lenses 45a and 45b may be disposed or more than three scanning lenses may be disposed. The number and positions of the flat mirrors 47a, 47b, and 47c may be set suitable for the structure of the light paths, etc.

In one embodiment, the light-blocking ribs 70 that block flare light generated from the light beams D2 and D3 are provided. Instead, however, when the flare light from the light beams D1 and D4 enter the first scanning lenses 45b and 45a, respectively, and reach the photoconductive drums 1d and 1a, respectively, the light-blocking ribs 70 that protrude from above (the side of the upper surface 48b of the housing 48 (see FIG. 3)) in a downward direction toward the light beams D1 and D4 deflected at the polygon mirror 44 may be provided.

In the optical scanning device 4 of this embodiment, the polygon mirror 44 is disposed at substantially the center of the housing 48 and the light beams D1 and D2 and the light beams D3 and D4 are deflected in opposite directions. Furthermore, the optical scanning device 4 is a four-beam type in which the light beams D1 and D2, which are deflected in the same direction, are separated from each other and the light beams D3 and D4, which are deflected in the same direction, are separated from each other and light beams D1, D2, D3 and D4 reach photoconductive drums 1a, 1b, 1c, and 1d. However, the optical scanning device 4 according to the present invention is not limited to a four-beam type optical scanning device, and other multi-beam type optical scanning devices may be employed.

For example, the optical scanning device 4 may be a two-beam type in which the light beams D1 and D2 (or D3 and D4) are deflected in opposite directions and reach photoconductive drums 1a and 1b (or 1c and 1d). In such a case, two optical scanning devices 4 may constitute an image forming device apparatus 100.

What is claimed is:

1. An optical scanning device comprising:
alight source configured to emit a plurality of light beams as first light beams,
a deflecting unit configured to deflect and scan the first light beams emitted from the plurality of light sources as second light beams having a scanning line that is substantially arc shaped,
a scanning lens disposed in a light path of at least one of the second light beams deflected and scanned by the deflecting unit, and
a light-blocking member interposed between the deflecting unit and the scanning lens;
wherein the light-blocking member is configured to (i) block reflected light generated from the at least one second light beam when the at least one second light beam enters the scanning lens, (ii) protrude toward the scanning line of the second light beams along at least a scanning area of the second light beams, and (iii) include a protruding edge section closest to the scanning line and curved in an arc shape.

2. The optical scanning device according to claim 1, wherein the protruding edge section has substantially the same arc shape as the scanning line of the second light beams.

3. The optical scanning device according to claim 1, wherein the scanning lens comprises a pair of scanning lenses facing each other with the deflecting unit interposed between the pair of scanning lenses.

4. The optical scanning device according to claim 1, wherein the first light beams enter the deflecting unit in a sub-scanning direction at different angles.

5. The optical scanning device according to claim 4, wherein at least one of the first light beams enter from above with respect to the deflecting unit, and the at least one second light beam is deflected and scanned downward with respect to the deflecting unit.

6. The optical scanning device according to claim 1, wherein the light-blocking member protrudes upward from a lower area of a housing.

7. The optical scanning device according to claim 6, wherein the protruding edge section is formed oblique in a traveling direction of the at least one second light beam.

8. The optical scanning device according to claim 1, wherein the light-blocking member protrudes downward from an upper area of a housing.

9. The optical scanning device according to claim 8, wherein the protruding edge section is formed oblique in a traveling direction of the at least one second light beam.

10. The optical scanning device according to claim 1, wherein the light-blocking member has substantially the same length as the scanning area of the at least one second light beam.

11. The optical scanning device according to claim 1, wherein the light-blocking member is formed integrally with a housing.

12. The optical scanning device according to claim 1, wherein the light-blocking member is substantially arc shaped and centered at a position relative to a rotary shaft of the deflecting unit.

13. The optical scanning device according to claim 12, wherein a flow of heated air generated in the periphery of the deflecting unit is prevented from being disturbed by the arc shaped light-blocking member.

14. The optical scanning device according to claim 1, wherein the light-blocking member protrudes toward the scanning line of the second light beams but does not substantially extend into the scanning line.

15. An image forming apparatus comprising:
at least two image forming sections each having an image carrier carrying a toner image;
a transfer unit configured to transfer the toner image formed by the image forming section onto a recording medium;
a fixing unit configured to fix the toner image transferred by the transfer unit on the recording medium; and
an optical scanning device configured to form electrostatic latent images on the image carriers,
wherein the optical scanning device comprises:
a light source configured to emit a plurality of light beams as first light beams,
a deflecting unit configured to deflect and scan the first light beams emitted from the plurality of light sources as second light beams having a scanning line that is substantially arc shaped,
a scanning lens disposed in a light path of at least one of the second light beams deflected and scanned by the deflecting unit, and
a light-blocking member interposed between the deflecting unit and the scanning lens;
wherein the light-blocking member is configured to (i) block reflected light generated from the at least one second light beam when the at least one second light beam enters the scanning lens, (ii) protrude toward the scanning line of the second light beams along at least a scanning area of the second light beams, and (iii) include a protruding edge section closest to the scanning line and curved in an arc shape.

16. A method of reducing image degradation in an optical scanning device comprising:
interposing a light-blocking member between a deflecting unit and a scanning lens, the deflecting unit configured to deflect and scan first light beams from a light source as second light beams having scanning lines that are substantially arc shaped;
wherein the light-blocking member is configured to (i) block reflected light generated from at least one of the second light beams when the at least one second light beam enters the scanning lens, (ii) protrude toward the scanning line of the second light beams along at least a scanning area of the second light beams, and (iii) include a protruding edge section closest to the scanning line and curved in an arc shape.

17. The method of claim 16, wherein the protruding edge section has substantially the same arc shape as the scanning line of the second light beams.

18. The method of claim 16, wherein the light-blocking member protrudes upward from a lower area of a housing.

19. The method of claim 18, wherein the protruding edge section is formed oblique in a traveling direction of the at least one second light beam.

20. The method of claim 16, wherein the light-blocking member protrudes toward the scanning line of the second light beams but does not substantially extend into the scanning line.
